(19) United States
(12) Patent Application Publication
(10) Pub. No.: US 2024/0348543 A1
(43) Pub. Date: Oct. 17, 2024

(54) Encoding Device-Type Identifiers with Captured Mobile Data Packets

(71) Applicant: EXFO Solutions SAS, Saint-Jacques de la Lande (FR)

(72) Inventors: Ángel DURÁN ALCAIDE, Pontevedra (ES); María Amparo NAVARRO PERIS, València (ES); Maria Victoria BAUSÁ ARAGONÉS, València (ES); Pau USACH MOLINA, València (ES)

(73) Assignee: EXFO Solutions SAS, Saint-Jacques de la Lande (FR)

(21) Appl. No.: 18/624,709

(22) Filed: Apr. 2, 2024

Related U.S. Application Data
(60) Provisional application No. 63/579,623, filed on Aug. 30, 2023.
(60) Provisional application No. 63/458,723, filed on Apr. 12, 2023.

(51) Int. Cl. H04L 45/74; H04L 69/22

(52) U.S. Cl. CPC H04L 45/74; H04L 69/22

(57) ABSTRACT

Systems and methods for monitoring data packets captured from a network are provided. A method, according to one implementation, includes the step of receiving raw data from a network, where the raw data pertains to mobile communications involving a Network Element (NE). The method also includes the step of extracting information from the raw data to obtain NE information defining a device type, such as network element type, and other information that characterizes the NE. Also, the method includes the step of encoding the NE information in a header of a Packet Capture (PCAP) file.

### CROSS-REFERENCE TO RELATED APPLICATION

The present application claims priority to U.S. Provisional Patent Application No. 63/579,623, filed Aug. 30, 2023, and U.S. Provisional Patent Application No. 63/458,723, filed Apr. 12, 2023, the contents of each are incorporated by reference herein in their entirety.

### TECHNICAL FIELD

The present disclosure generally relates to networking systems and methods. More particularly, the present disclosure relates to capturing mobile data packets and encoding network element type, technology type, and network element identify identifiers with the captured data packets.

### BACKGROUND

For troubleshooting a telecommunications network, various processes for capturing data packets can be used. For example, PCAP is a networking practice that involves the interception of data packets travelling over a network. Once the data packets are obtained, they can be stored for further analysis. The inspection of these data packets allows a user (e.g., a network operator, third party technician, etc.) to determine network status, identify issues that might affect daily operations, and attempt to solve network problems by controlling network traffic routing, replacing defective equipment, etc. Many monitoring devices may be configured to create PCAP (Packet Capture) files from the captured data packets. The PCAP files may contain detailed information about the data packets, including the IP addresses of the source and destination components, the time when the packets were captured, protocol information, etc. Examples of PCAP files may include WinPCAP, LibPCAP, NPCAP, and PCAPng, among others.

### BRIEF SUMMARY

The present disclosure is directed to various systems and methods for monitoring data packets that have been monitored in a communications network, such as a mobile network, and encoding information in a header of a standardized packet-capture file. According to one implementation, a data packet monitoring method may include the step of receiving raw data from a network, where the raw data may be related to a call trace pertaining to mobile communications involving a Network Element (NE). The method also includes the step of extracting information from the raw data to obtain NE information defining a device type, such as network element type, and other information that characterizes the NE. Also, the method includes the step of encoding the NE information in a header of a standardized packet capturing file. In some embodiments, the standardized packet capturing file may be a Packet Capture (PCAP) file.

According to some embodiments, the method may include extracting identification data from the raw data, whereby the identification data may include a first set of parameters regarding a source component, such as, one configured to transmit mobile data packets, and a second set of parameters regarding a destination component, such as, one configured to receive the mobile data packets, where one of the source component and destination component may be the NE.

The identification data may further include NE-identity information and technology-type information, wherein the NE-identity information includes an identifier assigned to the NE by a network operator associated with the network, and wherein the technology-type information defines a type of technology according to which the NE is operating. In some embodiments, the method may further be configured to a) structure the header to include an NE-identity field, an NE-type field, and a technology-type field, b) encode the NE-identity information in the NE-identity field, c) encode the NE-type in the NE-type field, and d) encode the technology-type information in the technology-type field. The NE-identity field may be eight bytes; the NE-type field may be one byte; and the technology-type field may be one byte. The method may also include the step of encoding the NE-type and technology-type information in a four-digit hexadecimal number.

The header may be a packet header, and the method may further include constructing the standardized packet capturing file by placing the identification data in the packet header and placing the raw data as payload in a packet following the packet header. The packet header may be a 16-byte packet header configured in the IPV6 address format.

The method may further be configured to monitor the raw data from the network and store the raw data in memory. The method may also display the NE-type in human-readable form to allow a user to troubleshoot the network. Furthermore, the method may also a) decode the NE-type to characterize the NE, and b) display the device type in human-readable form on a user interface.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a diagram illustrating a data file structure for a Packet CAPture (PCAP) file, according to one embodiment.

FIG. 2 is a diagram illustrating a simple file structure of raw data, such as data related to mobile communications, according to one embodiment.

FIG. 3 is a block diagram illustrating a computer system for monitoring data packets, according to various embodiments.

FIG. 4 is a diagram illustrating a three-stage process for capturing and managing data packets, according to various embodiments.

FIG. 5 is a table illustrating a header for captured packets, according to various embodiments.

FIG. 6 is a table illustrating hexadecimal value representations for technology-type information for the header of FIG. 5, according to various embodiments.

FIG. 7 is a table illustrating hexadecimal value representations for the types of devices characterizing a number of Network Elements (NEs), according to various embodiments.

FIG. 8 is a table showing an example of values added to the table of FIG. 5, according to various embodiments.

FIG. 9 is a table showing a decoding of values included in the table of FIG. 5, according to various embodiments.

FIG. 10 is a table showing an encoding of identification information, according to various embodiments.

FIG. 11 is a flow diagram illustrating a method for encoding information in a header of a standardized packet-capture file, according to various embodiments.

### DETAILED DESCRIPTION

The present disclosure relates to systems and methods for monitoring and storing data packets, converting raw packet data into a standardized format, encoding identification information in a header, and allowing a user to view the encoded identification information to easily obtain parameters regarding Network Element (NEs), such as source components and destination components. The NEs in some embodiments may be mobile device components using various wireless technologies. According to some implementations, the identification information in each header may include a) “NE identification” information that identifies the NE as assigned by a network operator, b) “NE-type” information that defines a type of device that best characterizes the NE, and c) “technology-type” information that defines a technology within which the NE is operating.

Again, packet capturing practices (e.g., PCAP) are configured to capture or intercept data packets that are travelling over a telecommunications network. The captured data packets can be stored and then used, when needed, for performing various troubleshooting tasks. PCAP files usually contain detailed information about the data packets (e.g., IP addresses, time of capture, protocol information, etc.).

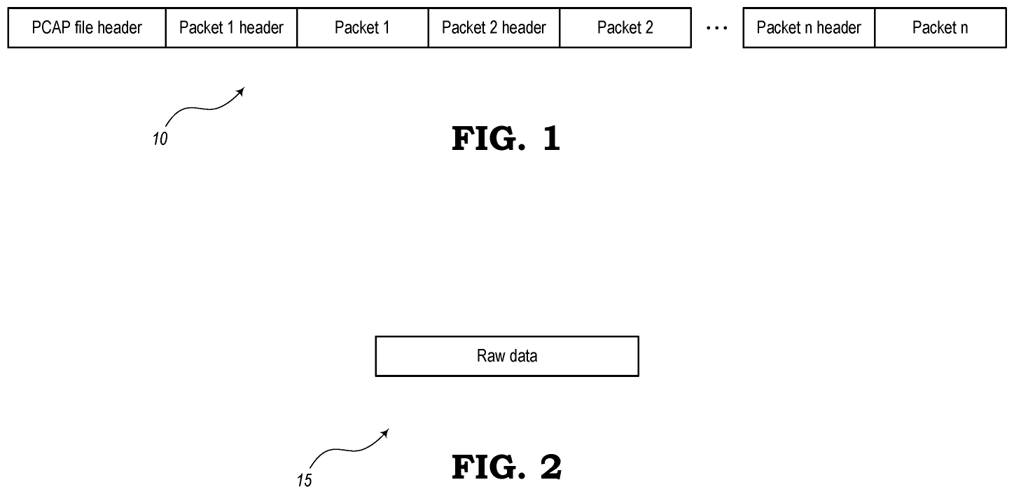

FIG. 1 is a diagram illustrating an embodiment of the structure of a PCAP file 10. Although the format of PCAP files may vary from one implementation to another, the PCAP files will normally include the same general structure. For example, in the illustrated embodiment, the PCAP file 10 includes a PCAP file header (e.g., 24-byte header), which is then followed by one or more records of captured data packets. Each captured packet in the PCAP file 10 may be prefixed by a packet header (e.g., 16 bytes). Following each packet header is the actual packet data that was being transferred over the network and may be written to the PCAP file 10 exactly as it was received, without regard for endianness or correctness of the data. As shown in the example of FIG. 1, the PCAP file 10 includes n packets (i.e., Packet 1, Packet 2, . . . , Packet n), where each packet follows a corresponding packet header (i.e., Packet 1 header, Packet 2 header, . . . . Packet n header).

FIG. 2 is a diagram illustrating an embodiment of a simple file structure 15 of raw data that may be monitored in a network, such as mobile data related to mobile communications within a cellular network. For example, mobile data may be monitored in a process that produces one or more “call traces.” A call trace can be retrieved from the telecommunications network, whereby the raw data of the simple file structure 15 does not include any header or any other type of information regarding the network, TCP/IP stack, mobile network protocols, etc. Call traces usually just contain the raw data of real messages interchanged between NEs, but without the protocol stack information. That is, the call trace messages can simply be considered to be the payload of the network packets without other accompanying detail information.

Nevertheless, according to the various embodiments of the present disclosure, it would be desirable to generate a file in the format of a standardized or commonly used packet capturing structure (e.g., PCAP, PCAPng) and then place the raw data of the call traces in the packet capturing file to allow the monitored mobile messages to be handled in a normal manner. However, since the monitored mobile information does not normally contain any header information (e.g., transport layer headers), the present disclosure is configured to take the raw data of the call traces (as shown in FIG. 2) and encode this information into a format that can be easily handled by a network operator or other technician.

It should be understood that the raw data of the call traces cannot be used to directly generate a PCAP file, particularly since information for creating headers of the protocol stacks is not readily available. Although some of the fields can be set by default, source and destination information of the IP/TCP protocol stack is normally missing. Since this information is essentially relevant for identifying a NE that is either generating or receiving the messages, the embodiments of the present disclosure are configured to obtain the information and encode it into the standardized format. Without this information, a PCAP file, which may be output from a monitoring tool (e.g., Radio Access Network (RAN) cloud parser, etc.) will not include information that can be easily read by a network operator since it would not contain the necessary information to follow the information flow. Thus, the PCAP file format, as created by the systems and methods described herein, is configured to display the raw data to allow a user to identify source and destination devices based on the IP layer. Thus, the present disclosure is configured to supplement the data gathered in the call traces to fully comply with the PCAP standard content.

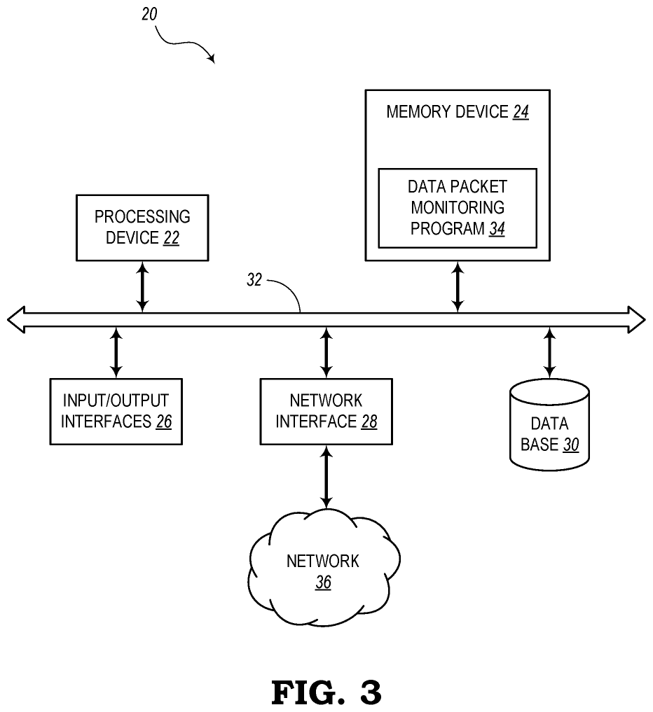

FIG. 3 is a block diagram illustrating an embodiment of a computer system 20 for monitoring data packets. In the illustrated embodiment, the computer system 20 may be a digital computing device that generally includes a processing device 22, a memory device 24, Input/Output (I/O) interfaces 26, a network interface 28, and a database 30. It should be appreciated that FIG. 3 depicts the computer system 20 in a simplified manner, where some embodiments may include additional components and suitably configured processing logic to support known or conventional operating features. The components (i.e., 22, 24, 26, 28, 30) may be communicatively coupled via a local interface 32. The local interface 32 may include, for example, one or more buses or other wired or wireless connections. The local interface 32 may also include controllers, buffers, caches, drivers, repeaters, receivers, among other elements, to enable communication. Further, the local interface 32 may include address, control, and/or data connections to enable appropriate communications among the components 22, 24, 26, 28, 30.

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, at least one processor, circuit/circuitry, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by one or more processors (e.g., any type of programmable circuitry or logic) that, in response to such execution, cause the one or more processors to perform a set of operations, steps, methods, processes, algorithms, functions, techniques, etc. as described herein for the various embodiments.

In particular, the computer system 20 includes a data packet monitoring program 34, which may be implemented in any suitable combination of hardware, software, firmware, etc. For example, the data packet monitoring program 34 may be stored in a non-transitory computer-readable medium (e.g., the memory device 24) and may include computer code, logic, instructions, etc. for enabling the processing device 22 to perform certain functions related to the monitoring and handling of data packets that may be received in a network 36.

The data packet monitoring program 34 may be configured to dynamically generate unique identifiers for Network Elements (NEs) in a synthetic way based on the information contained in the messages (e.g., mobile messages of monitored call traces) that allows a user (e.g., network operator) to identify the NEs and their types. In some embodiments, the data packet monitoring program 34 may not only be configured to display (or readily expose) the “NE-type,” but it can also display (or readily expose) the type of technology (i.e., “technology-type”) in which the NE is operating. In some cases, the network operator can determine the NE-type and technology-type by simply looking at a four-digit hexadecimal number that may be written in a certain format, such as the IPv6 form, where this number can be easily spotted.

In one embodiment, the identifiers can be generated as a combination of internal identifiers and default internal identifiers for differentiating elements and technology. In one embodiment, the unique identifier can fit within an IP address. For example, the unique identifier can be provided in the IPV6 format. Thus, the bytes of the identifier can be organized for using a specific block within the IPV6 format to indicate the element type (i.e., NE-type). In some embodiments, the source and destination of the call traces can be retrieved based on internal mobile network identifiers. Then, a unique identifier can be generated for the source and another one can be generated for the destination. Additionally, information can be generated and added in the standardized form (e.g., PCAP format) as source IP and destination IP.

According to one embodiment, a method may be configured for dynamically generating a unique identifier for a NE in a synthetic way based on the information contained in the messages that allows a user to identify the element and its type. Also, it can also identify the technology. The synthetic identifiers can be generated as a combination of internal identifiers and default internal identifiers for differentiating elements and technology. The unique identifier again can fit within an IP address structure (e.g., within the IPV6 format).

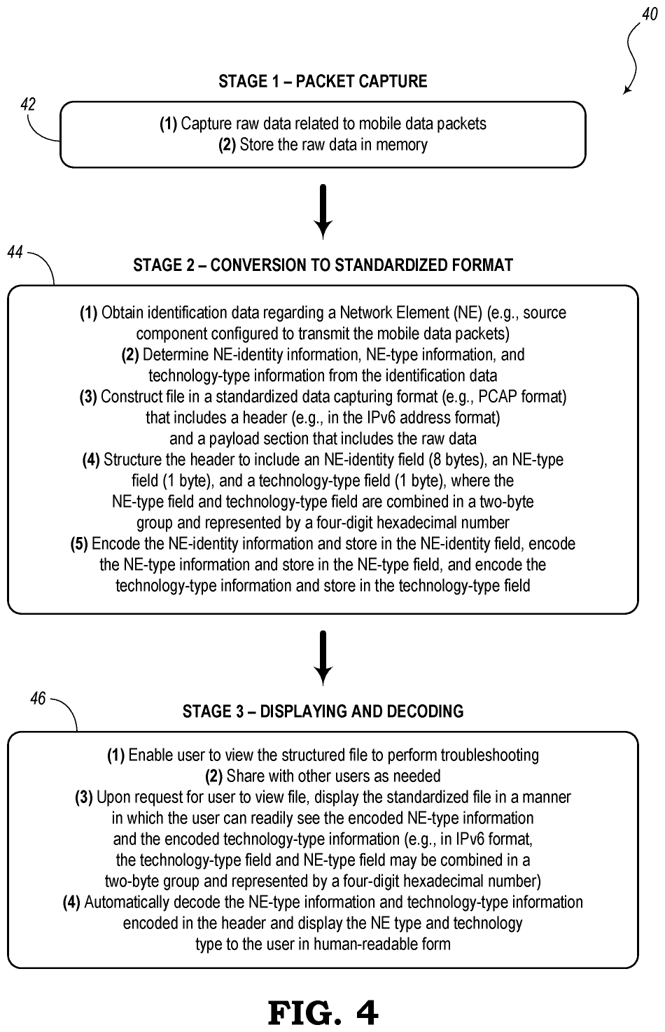

FIG. 4 is a diagram illustrating an embodiment of a three-stage process 40 for capturing and managing data packets. In some embodiments, the three-stage process 40 may be executed, in part or in whole, by the data packet monitoring program 34 shown in FIG. 3. The first stage 42 is related to packet capturing and may include 1) monitoring raw data related to mobile data packets and 2) storing the raw data in memory. According to some embodiments, the first stage 42 may be performed external to the computer system 20 and the stored data may be provided to the data packet monitoring program 34 for further processing.

The second stage 44 of the three-stage process 40 may include steps for converting the raw data to a standardized format. In some embodiments, the second stage 44 may include 1) obtaining identification data regarding a NE (e.g., a source component), 2) determining NE-identity information, NE-type, and technology-type information from the identification data, 3) constructing a file in a standardized data capturing format (e.g., PCAP format) that includes a header (e.g., in the IPV6 address format) and a payload section that includes the raw data. Next, the second stage 44 may include 4) structuring the header to include an NE-identity field (e.g., 8 bytes), an NE-type field (e.g., 1 byte), and a technology-type field (e.g., 1 byte). For example, the NE-type field and technology-type field may be combined in a two-byte group and represented by a four-digit hexadecimal number. The second stage 44 may then include the step of 5) encoding the NE-identity information and storing the encoded result in the NE-identity field, encoding the NE-type information and storing the encoded result in the NE-type field, and encoding the technology-type information and storing the encoded result in the technology-type field.

After conversion to the standardized format, the three-stage process 40 may include a third stage 46 related to displaying and decoding the various identification information. For example, the third stage 46 may include 1) enabling the user to view the structure file to perform troubleshooting and/or 2) sharing the file with other users as needed. In some implementations, the third stage 46 may also include 3) upon request from a user to view the file, display the standardized file in a manner in which the user can readily see the encoded NE-type and the encoded technology-type information (e.g., in the IPV6 format, where the technology-type field and NE-type field can be combined in a two-byte group and represented by a four-digit hexadecimal number). Alternatively, the third stage 46 may include 4) automatically decoding the NE-type information and technology-type information encode in the header and display the NE type and technology type to the user in human-readable form.

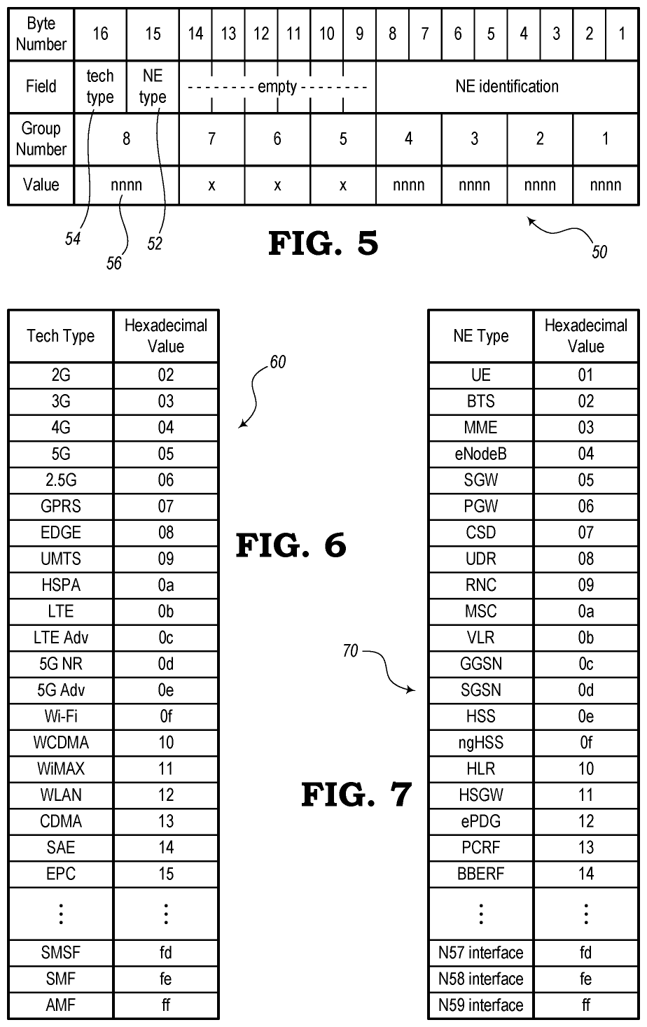

FIG. 5 is a table illustrating an example of a structure of a header 50 for captured packets. As shown in this example, the header 50 may include 16 bytes, shown from the most significant Byte 16 to the least significant Byte 1. Similar to the format of IPv6, which includes 16 bytes (i.e., 128 bits), the bytes are organized into eight groups each containing two bytes (or 16 bits). The groups are numbered from Group 8 to Group 1, where Bytes 16 and 15 are part of Group 8, Bytes 14 and 13 are part of Group 7, Bytes 12 and 11 are part of Group 6, and so on. Thus, each group (e.g., containing two bytes or 16 bits) can be represented by a four-digit hexadecimal number.

In some embodiments, the NE that is represented by the header 50 can be identified by the “NE identification,” which may be includes in Bytes 8-1 (i.e., Groups 4 1). The information regarding the NE identification may be encoded in the header 50 and include up to 16 hexadecimal digits (e.g., values 0000:0000:0000:0000 through ffff:ffff:ffff:ffff). The NE identification may include information added by a network operator for identifying the NE.

In accordance with various embodiments of the present disclosure, the header 50 also includes a new field referred to herein as the NE-type field 52. In some embodiments, Byte 15 of the header 50 may represent the NE-type field 52, enabling NE-type information to be written into Byte 15. The NE-type field 52 defines the type of device of the NE. For example, FIG. 7 shows an example of various values that can be used to represent certain types of NEs. In mobile communications, the NE may be User Equipment (UE), a Base Transceiver Station (BTS), a Mobility Management Entity (MME), an eNodeB, etc. Each type of device may be encoded using a two-digit hexadecimal number as shown in FIG. 7.

Likewise, in accordance with some additional embodiments, the header 50 may also include a new field referred to herein as the technology-type field 54. In some embodiments, Byte 16 of the header 50 may represent the technology-type field 54, enabling technology-type information to be written into Byte 16. For example, FIG. 6 shows an example of various values that can be used to represent certain types of mobile technologies. The technologies may be 2G, 3G, 4G, 5G, etc. Each type of technology may be encoded using a two-digit hexadecimal number as shown in FIG. 6.

According to other embodiments, the NE-type field 52 and technology-type field 54 may be represented in any of Bytes 16 to 9, whichever may be available. It may be noted, however, that the positioning of the technology-type and NE-type in Bytes 16 and 15, the four-digit hexadecimal value 56 representing these two fields will be at the front of the value and can be more easily spotted by casual observer of the network operator.

FIG. 6 is a table 60 illustrating an example of hexadecimal value representations for technology-type information associated with the technology-type field 54 for the header 50 of FIG. 5. It should be noted that any suitable types of technology may be represented in the header 50 and any suitable hexadecimal representation may be used for each technology. Therefore, the present disclosure is not meant to be limited by the particular contents of the specific technologies and values shown in FIG. 6.

FIG. 7 is a table 70 illustrating an example of hexadecimal value representations for the types of devices characterizing a number of Network Elements (NEs), such as those used in the various technologies shown in FIG. 6. It should be noted that any suitable types of NEs may be represented in the header 50 and any suitable hexadecimal representation may be used for each NE. Therefore, the present disclosure is not meant to be limited by the particular contents of the specific NEs and values shown in FIG. 7. Furthermore, if more or fewer technologies and/or NEs are meant to be represented, it should be understood that the representations (values) of the available technologies and NEs may include more or fewer bits, bytes, groups, etc. for representing them.

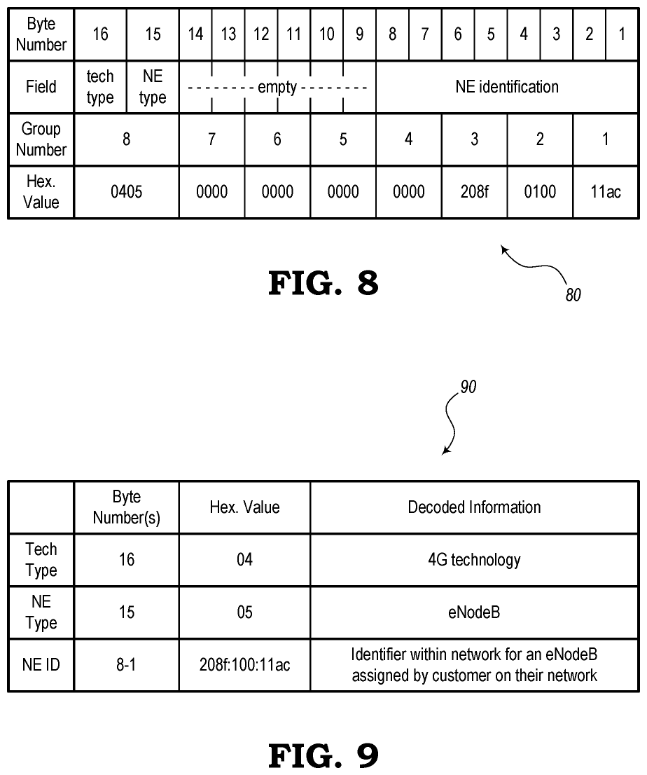

FIG. 8 is a table 80 showing an example of hexadecimal values added to the table 50 of FIG. 5. In this example, the technology type has value 04 and the NE type has value 05. Thus, Group 8 (including the technology-type field and NE-type field) will have hexadecimal value 0405. Bytes 14 through 9 may be empty in this example, or may include additional information, as needed. Bytes 8 through 1 include the NE identification, which, in this case, has value 0000:208f: 0100:11ac. Therefore, the hexadecimal representation of the entire header 50 may be divided into the eight groups and written as “0405:0000:0000:0000:0000:208f: 0100:11ac,” which is consistent with the IPV6 format. This value can be compressed, similar to IPV6 compression, as “405::208f: 100:11ac,” although according to some embodiments it may be preferable to write the first group as “0405” in order to clearly show the two fields of the technology-type (i.e., “04”) and the NE-type (i.e., “05”) as described in the present disclosure.

FIG. 9 is a table 90 showing a decoding of values included in the table of FIG. 5. It may be noted that the decoded may be performed by the network operator (having a decoding sheet or other guide) or may be performed automatically using the data packet monitoring program 34 or another suitable decoding device. As such, the first group of numbers in the header 80, according to this example, is “0405” written in the IPV6 address style. Thus, according to the example tables 60, 70 of FIGS. 6 and 7, respectively, the technology type and NE type can be determined. That is, by taking “04” from Byte 16, the technology type can be decoded as “4G technology” (as shown in FIG. 6) and by taking “05” from Byte 15, the NE type can be decoded as “eNodeB” (as shown in FIG. 7). Also, the NE-identification can be determined by looking at Bytes 8-1, where the value 208f: 100:11ac can be used to determine a particular identifier assigned by a customer (e.g., network operator) within their network.

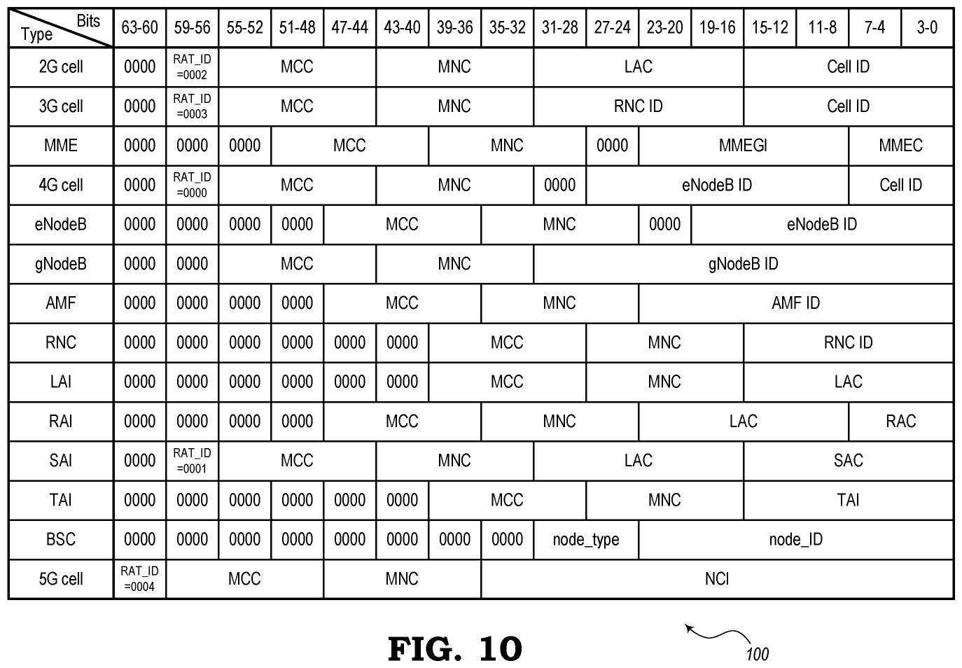

FIG. 10 is a table 100 showing an encoding of identification information according to another implementation. In some cases, the table 100 may show the ID identification information represented in Bytes 8-1 of the header 50. In this example, 64 bits are available and may represent different identifications based on the type of technology used. It may be noted that the technology types include a different order than depicted in FIG. 6.

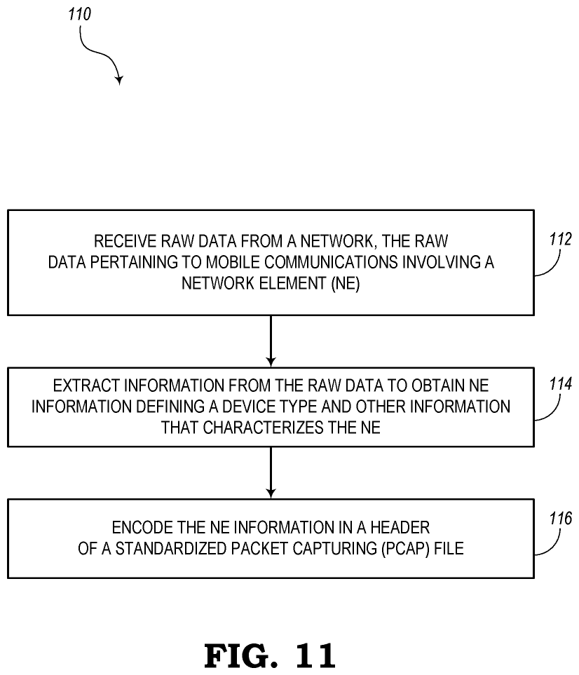

FIG. 11 is a flow diagram illustrating an embodiment of a method 110 for encoding information in a header of a standardized packet-capture file, according to various embodiments. As shown, the method 110 includes the step of receiving raw data captured from a network, as indicated in block 112, where the raw data is related to a call trace pertaining to mobile communications involving a Network Element (NE). The method 110 also includes the step of extracting information from the raw data to obtain NE information defining a device type and other information that characterizes the NE, as indicated in block 114. Also, the method 110 includes the step of encoding the NE information in a header of a standardized packet capturing file, as indicated in block 116. In some embodiments, the standardized packet capturing file may be a Packet Capture (PCAP) file.

According to some embodiments, the method 110 may include extracting identification data from the raw data, whereby the identification data may include a first set of parameters regarding a source component and a second set of parameters regarding a destination component, where one of the source component and destination component may be the NE.

As part of the NE information, the identification data may include NE-type, NE-technology and NE-identity, wherein the NE-identity information includes an identifier assigned to the NE by a network operator associated with the network, and wherein the technology-type information defines a type of technology according to which the NE is operating. In some embodiments, the method 110 may further be configured to a) structure the header to include an NE-identity field, an NE-type field, and a technology-type field, b) encode the NE-identity information in the NE-identity field, c) encode the NE-type in the NE-type field, and d) encode the technology-type information in the technology-type field. The NE-identity field may be eight bytes; the NE-type field may be one byte; and the technology-type field may be one byte. The method 110 may also include the step of encoding the NE-type and technology-type information in a four-digit hexadecimal number.

The header described in block 116 may be a packet header, and the method 110 may further include constructing the standardized packet capturing file by placing the identification data in the packet header and placing the raw data as payload in a packet following the packet header. The packet header may be a 16-byte packet header configured in the IPV6 address format.

The method 110 may further be configured to capture the raw data from the network and store the raw data in memory. The method 110 may also display the NE information in human-readable form to allow a user to troubleshoot the network. Furthermore, the method 110 may also a) decode the NE information to characterize the NE, and b) display the device type in human-readable form on a user interface.

Therefore, the NE identification may be a unique identifier of the network element within the same type of elements. This ID may be determined based on identifiers present in the network, which, when combined, generate a unique identifier of 64 bits. The combination of the different network IDs into a unique identifier is different per each network technology (e.g., 2G, 3G, 4G, 5G). The size of the NE identification may be eight bytes (64 bits) or may be equal to the size of an IPV4 address (i.e., four bytes or 32 bits).

Using the IPV6 format for the synthetic identifier allows to use up to 128 bits. As the NE type can fit into a single byte and as Bytes 8-1 are taken up by the NE identifier, there are still 7 bytes remaining that can be used to add extra information, such as the type of technology in which the network element is working. In other embodiments, the extra bytes may include a network element grouping or any other administrative or logical information about the call trace.

Although the present disclosure has been illustrated and described herein with reference to various embodiments and examples, it will be readily apparent to those of ordinary skill in the art that other embodiments and examples may perform similar functions, achieve like results, and/or provide other advantages. Modifications, additions, or omissions may be made to the systems, apparatuses, and methods described herein without departing from the spirit and scope of the present disclosure. All equivalent or alternative embodiments that fall within the spirit and scope of the present disclosure are contemplated thereby and are intended to be covered by the following claims.

What is claimed is:

1. A system comprising:
a processing device; and
a memory device configured to store a computer program having logic that enables the processing device to
receive raw data from a network, the raw data pertaining to mobile communications involving a Network Element (NE),
extract information from the raw data to obtain NE information defining a network element type and other information that characterizes the NE, and
encode the NE information in a header of a standardized packet capturing file.

2. The system of claim 1, wherein the standardized packet capturing file is a Packet Capture (PCAP) file.

3. The system of claim 1, wherein the logic further enables the processing device to extract identification data from the raw data, and wherein the identification data includes a first set of parameters regarding a source component.

4. The system of claim 3, wherein the identification data further includes a second set of parameters regarding a destination component.

5. The system of claim 3, wherein the identification data includes NE-identity information and technology-type information, wherein the NE-identity information includes an identifier assigned to the NE by a network operator associated with the network, and wherein the technology-type information defines a type of technology according to which the NE is operating.

6. The system of claim 5, wherein the logic enables the processing device to:
structure the header to include an NE-identity field, an NE-type field, and a technology-type field;
encode the NE-identity information in the NE-identity field;
encode NE-type information in the NE-type field; and
encode the technology-type information in the technology-type field.

7. The system of claim 6, wherein the NE-identity field is eight bytes, the NE-type field is one byte, and the technology-type field is one byte.

8. The system of claim 7, wherein the logic further enables the processing device to encode the NE-type information and technology-type information in a four-digit hexadecimal number.

9. The system of claim 3, wherein the header is a packet header, and wherein the logic further enables the processing device to construct the standardized packet capturing file by placing the identification data in the packet header and placing the raw data as payload in a packet following the packet header.

10. The system of claim 9, wherein the packet header is a 16-byte packet header configured in IPV6 address format.

11. The system of claim 1, wherein the logic further enables the processing device to capture the raw data from the network and store the raw data in memory.

12. The system of claim 1, wherein the logic further enables the processing device to display the NE information in human-readable form to allow a user to troubleshoot the network.

13. The system of claim 1, wherein the logic further enables the processing device to:
decode the NE information to determine NE-type, NE-technology, and NE-identity that characterizes the NE; and
display the NE-type, the NE-technology, and the NE-identity in human-readable form on a user interface.

14. A non-transitory computer-readable medium configured to store computer logic having instructions that, when executed, cause one or more processing devices to:
receive raw data from a network, the raw data pertaining to mobile communications involving a Network Element (NE);
extract information from the raw data to obtain NE information defining a device type and other information that characterizes the NE; and
encode NE-type information in a header of a Packet Capture (PCAP) file.

15. The non-transitory computer-readable medium of claim 14, wherein the instructions further cause the one or more processing devices to extract identification data from the raw data, and wherein the identification data includes a first set of parameters regarding a source component and a second set of parameters regarding a destination component.

16. The non-transitory computer-readable medium of claim 15, wherein the identification data further includes NE-identity information and technology-type information, wherein the NE-identity information includes an identifier assigned to the NE by a network operator associated with the network, and wherein the technology-type information defines a type of technology according to which the NE is operating.

17. The non-transitory computer-readable medium of claim 16, wherein the instructions further cause the one or more processing devices to:
structure the header to include an NE-identity field, a one-byte NE-type field, and a one-byte technology-type field;
encode the NE-identity information in the NE-identity field;
encode NE-type information in the one-byte NE-type field;
encode the technology-type information in the one-byte technology-type field; and
represent the NE-type information and technology-type information as a four-digit hexadecimal number.

18. A method comprising steps of:
receiving raw data from a network, the raw data pertaining to mobile communications involving a Network Element (NE);
extracting information from the raw data to obtain NE information defining a device type and other information that characterizes the NE; and
encoding the NE information in a header of a standardized packet capturing file.

19. The method of claim 18, further comprising the steps of:
extracting identification data from the raw data, the identification data including at least a first set of parameters regarding a source component configured to transmit mobile data packets; and
construct the standardized packet capturing file by placing the identification data in the header and placing the raw data as payload in a packet following the header, wherein the header is a 16-byte packet header configured in IPV6 address format.

20. The method of claim 18, further comprising one or more of the steps of:
decoding the NE information to determine NE-type, NE-technology, and NE-identity that characterize the NE and displaying the NE-type, the NE-technology, and the NE-identity in human-readable form on a user interface.
